(19) United States
(12) Patent Application Publication
(10) Pub. No.: US 2019/0228423 A1
(43) Pub. Date: Jul. 25, 2019

(54) SYSTEM AND METHOD OF TRACKING ENGAGEMENT

(71) Applicant: PRODUCTIONS PLUS, INC., Bingham Farms, MI (US)

(72) Inventor: Nathan James Russell, Seal Beach, CA (US)

(21) Appl. No.: 16/257,360

(22) Filed: Jan. 25, 2019

Related U.S. Application Data
(60) Provisional application No. 62/621,646, filed on Jan. 25, 2018.

(51) Int. Cl. G06Q 30/02

(52) U.S. Cl. CPC G06Q 30/0202; G06Q 30/0281; G06Q 30/0201

(57) ABSTRACT

A system for tracking consumer engagements is described. The system can include a non-transitory computer-readable storage medium and a processor. The non-transitory computer-readable storage medium can include instructions executable by the processor to: receive first and second user input information corresponding to a first feature, store the first and second user input information in a memory associated with the processor, generate a first key metric using at least the first and second user input information, store the first key metric in the memory, and receive a report request from a third computing device. In response to the report request, the processor can retrieve, from the memory, a plurality of key metrics, including at least the first key metric; generate a report using the key metrics; and communicate, for display, the report to the third computing device.

### CROSS-REFERENCE TO RELATED APPLICATION(S)

This application claims priority to and the benefit of U.S. Provisional Application Patent Ser. No. 62/621,646, filed Jan. 25, 2018, the entire disclosure of which is hereby incorporated by reference.

### BACKGROUND

The present disclosure relates generally to a system and method for collecting data in the event marking industry (e.g., auto shows, trade shows, and live events), analyzing the data, and generating reports based on the analysis. Most consumer interactions in the event marketing industry are unmeasured and untracked. Event marketing executives and decision-makers use metrics to help measure the success of their programs; however, such metrics are not readily available for the event marketing industry. Metrics of such events could be compared to readily available metrics in the television and online sectors of marketing to determine the effectiveness of the events. The metrics would also help with future marketing strategies and planning within the event marketing industry.

### SUMMARY

This section provides a general summary of the present disclosure and is not a comprehensive disclosure of its full scope or all of its features, aspects, and objectives.

Disclosed herein are implementations of a system for tracking consumer engagements. The system can include a non-transitory computer-readable storage medium and a processor. The non-transitory computer-readable storage medium can include instructions executable by the processor to perform operations. The processor can receive, from a first computing device, a first user input information corresponding to a first feature. The processor can store the first user input information corresponding to the first feature in a memory associated with the processor. The processor can receive from a second computing device, a second user input information corresponding to the first feature. The processor can store the second user input information corresponding to the first feature in the memory. The processor can generate a first key metric using at least the first user input information and the second user input information corresponding to the first feature. The processor can store the first key metric in the memory. The processor can receive a first report request from a third computing device. In response to the first report request, the processor can retrieve, from the memory, a plurality of key metrics, including at least the first key metric; generate a first report using the plurality of key metrics; and communicate, for display, the first report to the third computing device.

Also disclosed herein are implementations of a non-transitory computer-readable storage medium, comprising executable instructions that, when executed by a processor of a computing device, facilitate a performance of operations for tracking consumer engagements. The processor can perform operations of receiving, from a plurality of user computing devices, a plurality of first input information corresponding to a first feature and storing the plurality of first input information in a memory associated with the processor. The processor can perform operations of generating a first key metric using the plurality of first input information and storing the first key metric in the memory. The processor can perform operations of receiving a report request from a client computing device. In response to the report request, the processor can perform operations of retrieving, from the memory, a plurality of key metrics, including at least the first key metric; generating a report using the plurality of key metrics; and communicating, for display, the report to the client computing device.

Also disclosed herein is a method for a consumer engagement system. The method can include receiving, from a first computing device, a first user input information corresponding to a first feature and storing the first user input information corresponding to the first feature in a memory associated with the processor. The method also can include receiving from a second computing device, a second user input information corresponding to the first feature and storing the second user input information corresponding to a first feature in the memory. The method can further include generating a first key metric using at least the first user input information and the second user input information corresponding to the first feature and storing the first key metric in the memory. The method can include receiving a first report request from a third computing device. In response to the first report request, the method can include retrieving, from the memory, a plurality of key metrics, including at least the first key metric; generating a first report using the plurality of key metrics; and communicating, for display, the first report to the third computing device.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a simplified block diagram depicting example components of the system in accordance with aspects of the present disclosure;

FIGS. 2-3 are an example home visual and an example report including a purchase funnel in accordance with aspects of the present disclosure;

FIG. 4 is a flow chart illustrating an example process of a consumer engagement tracking system in accordance with aspects of the present disclosure

FIG. 5 is an example report including a comparison of the previous five events in accordance with aspects of the present disclosure;

FIG. 6 is an example report, including a list of event details in accordance with aspects of the present disclosure;

FIG. 7 is an example report including a summary section of event details in accordance with aspects of the present disclosure;

FIG. 8 is an example report including a graph of the total number of consumer engagements over time at the event in accordance with aspects of the present disclosure;

FIG. 9 is an example report including a purchase path analysis of the event in accordance with aspects of the present disclosure;

FIG. 10 is an example report, including an impact of engagement length and purchase funnel stage of an event in accordance with aspects of the present disclosure;

FIGS. 11A and B are an example input interface in accordance with aspects of the present disclosure;

FIGS. 12-14 illustrate features of an example report in accordance with aspects of the present disclosure;

FIG. 15 is a flow chart illustrating an example process of a consumer engagement tracking system in accordance with aspects of the present disclosure.

### DETAILED DESCRIPTION

The following description is merely exemplary in nature and is not intended to limit the disclosure in its application or uses. For purposes of clarity, the same reference numbers are used in the description and drawings to identify similar elements.

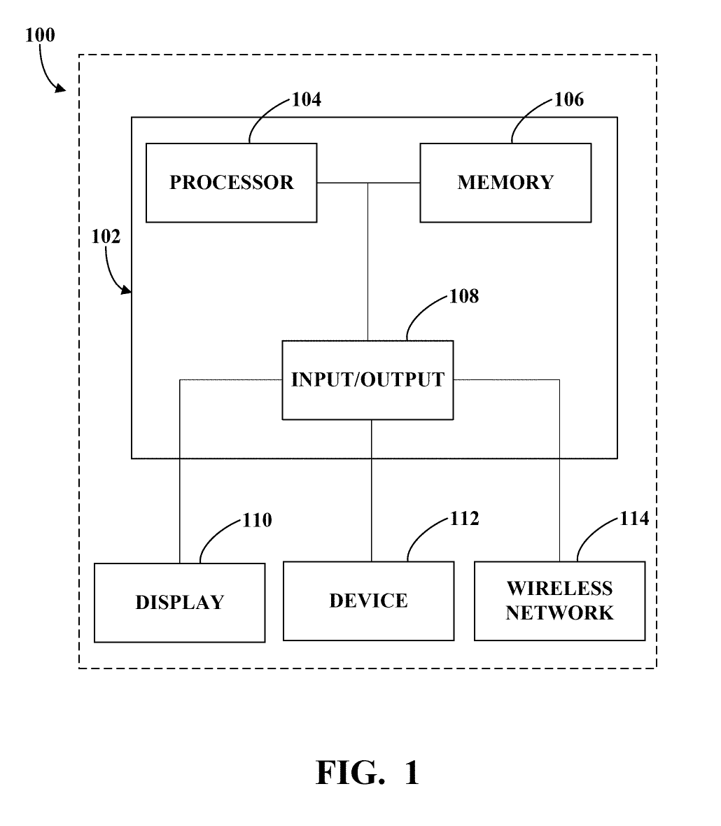

FIG. 1 is an illustrative block diagram depicting example components of a system 100 in accordance with aspects of the present disclosure. The system 100 may include additional and/or fewer components and is not limited to those illustrated in FIG. 1. The system 100 can include a control unit 102. The control unit 102 can include various components such as at least one microprocessor or processor 104, a memory 106, and an input/output 108. The control unit 102 may process data captured by a device 112. The device 112 may capture real-time information and data. The device 112 may be configured to receive input from a user, such as a trained talent (e.g., Product Specialist, Brand Ambassador, Host, etc.). The device may be, for example, a mobile phone, a tablet computer, a laptop computer, a desktop computer, a notebook computer, a server computer, or any other desired computing device. The system 100 can include a plurality of devices 112. For example, a plurality of users can input information into the plurality of devices 112 based on a plurality of consumer engagements. The control unit 102 can process data of consumer engagement at an event, such as the level or stage of consumer engagement at the beginning and end of the engagement with the trained talent, as well as the length of the engagement. The memory 106 can store data of the engagement. Using the record of data of previous engagements, the processor 104 can process the aggregate information collected and provide it in various formats for outputting, for example, to a display 110. The display 110 can be a display on the device 112, or a display associated with another device.

The processor 104 can be a device that processes signals and performs general computing and arithmetic functions. The processor 104 may include multiple single and multicore processors, co-processors, and architectures. The memory 106 may include a variety of memory, such as volatile memory and non-volatile memory. The memory 106 may also include a disk, such as but not limited to a flash memory card, a memory stick, a magnetic disk drive, a solid-state disk drive, a CR-ROM, or a DVD ROM. The memory 106 may store a system that controls resources of a computing device and software that the processor 104 executes. The processor 104 and memory 106 can be operatively coupled. The processor 104 performs processes by executing software instructions stored by the memory 106. The processes may include capturing data of the engagements surrounding the device 112. For example, the memory 106 can store an algorithm having software parameters for a processor to receive, from a first computing device, a first user input information corresponding to a first feature; store the first user input information in a memory associated with the processor; receive, from a second computing device, a second user input information corresponding the be first feature; store the second user input information in the memory; generate a first key metric using the first user input information and the second user input information; store the first key metric in the memory; and receive, a report request from a third computing device. The memory 106 can also store an algorithm having software parameters for a processor to retrieve from the memory, in response to the report request, a plurality of key metrics, including at least the first key metric, generate a report using the plurality of key metrics, and communicate the report to the third computing device for display. The algorithm may be embedded in the software of the device 112. The algorithm may be accessed via the wireless network 114, or via any other desired device or system.

The processor 104 and the memory 106 can communicate through the input/output 108. The input/output 108 may be a part of the system 100 and communicate with the device 112, the display 110, and the wireless network 114. The data captured by the device 112 can be input to the processor 104 for processing and outputting to the display 110 for providing analytics of the data analyzed. The analytics may be displayed on the device 112 for the trained talent to view or to another device, such as the display 110 for a remote user to view. The display 110 may be incorporated in the device 112 or it may be a separate component. The data and/or analytics may be transmitted via the wireless network 114 to another device, such as a computer or storage unit, such as the cloud, and viewable on the display 110.

In one example, the system 100 is an analytics system that can include a non-transitory computer readable medium, such as the memory 106, to store instructions of the system 100. The system 100 also can include the processor 104 that can be configured to execute the instructions. The processor 104 can further be configured to receive data, determine a length of an interaction, analyze the data and the length, and output an analysis.

In another example, the system 100 is an analytics system for tracking consumer engagement at an event that can include a microprocessor, or processor 104, and the device 112. The microprocessor can be configured to execute instructions stored on a non-transitory computer readable medium, such as the memory 106. The device 112 can be coupled to the microprocessor and configured to receive information. The microprocessor can be also configured to receive entrance data, exit data, and time data. The microprocessor can be further configured to analyze the entrance data, exit data, and time data, generate an analysis based on the analyzed data, and output the analysis.

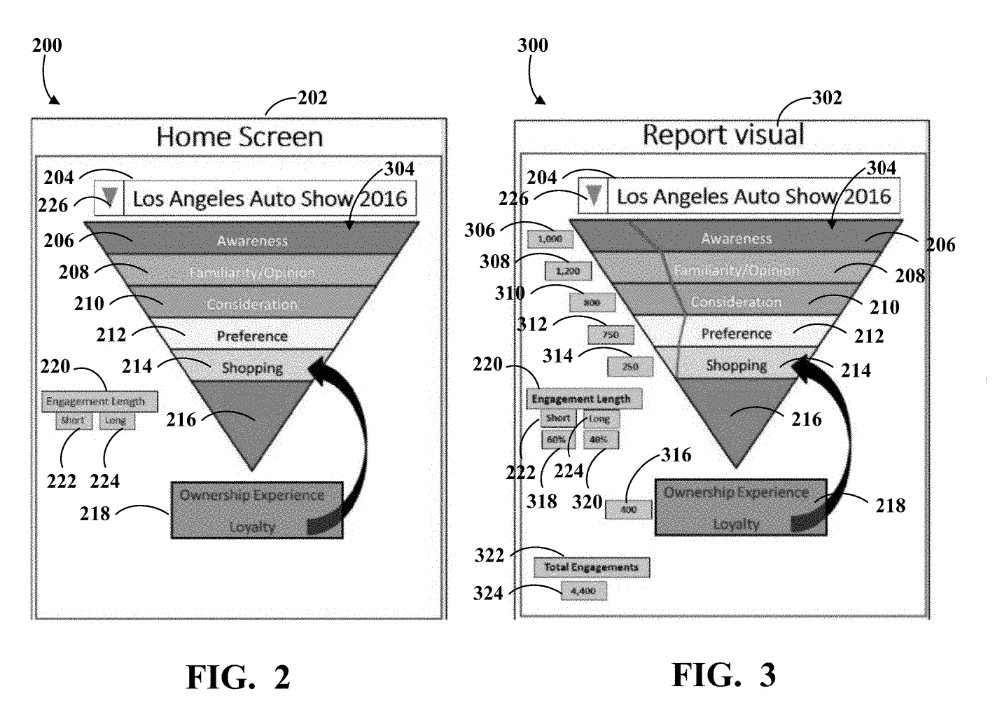

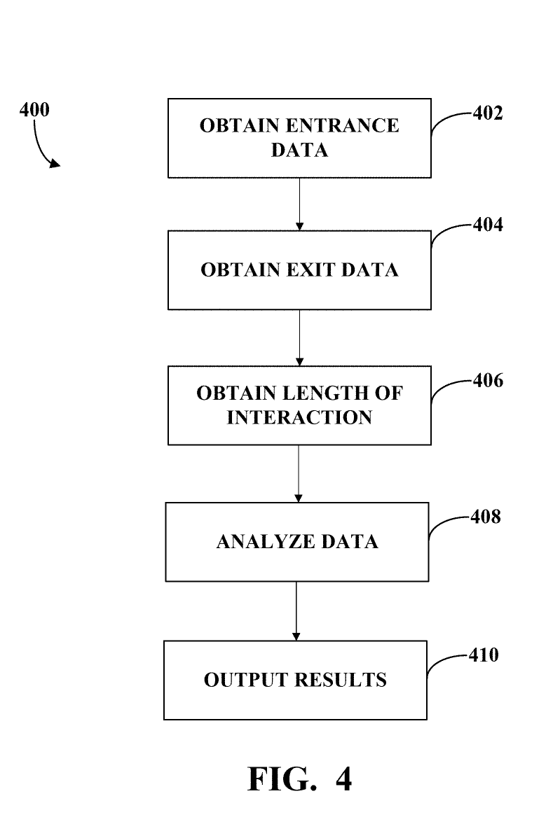

FIGS. 2-3 illustrate examples of a home visual 200 and a report visual 300 in accordance with aspects of the present disclosure. The home visual 200 and report visual 300 can be example pages, reports, graphics, or features of the system 100. The system 100 may include a consumer engagement tracker (CET) application, wherein the CET application can generate the home visual 200 and the visual 300. The CET application can provide useful, quantified metrics to users of the CET application beyond simple consumer purchasing leads. The metrics in the CET application can show the successes of programs within an organization, which may justify continuing the programs or increasing funding for such programs. The home visual 200 can display a page that users, such as the trained talent (e.g., product specialists), may access after the trained talent finishes a consumer engagement interaction. The trained talent may utilize the home visual 200 to log quickly each interaction with a consumer throughout a given event. The report 302 can illustrate a chart of the total engagements with a team of trained talent as plot points on a purchase funnel 304, as well as the total number of consumer engagements. The report 302 can provide a visual for users to view, such as for internal reporting. Another user, such as a manager or a client, may also be able to access the home visual 200 and the report visual 300 to access the report 302 or any other desired information or features.

The home visual 200 and the report visual 300, include similar features. For example, each can include a ribbon (e.g., a home screen 202 and a report 302, respectively). Each can also include a drop down box 226, which when selected, can provide a list of events to view and further select. After an event 204, such as “Los Angeles Auto Show 2016,” is selected from the drop down box 226, an analysis, such as a purchase funnel analysis, can populate on the report visual 300. Each can also include the purchase funnel 304, such as an upside down triangle or funnel, broken up into multiple categories or stages, or any other desired shape or configuration. The stages can include an awareness stage 206, a familiarity/opinion stage 208, a consideration stage 210, a preference stage 212, a shopping stage 214, and an other stage 216. Positioned below purchase funnel 304, may include a section for ownership experience/loyalty 218, which in this example, includes a rectangular box and circles back to the shopping stage 214. The report 302 can also include a consumer engagement length 220, such as a short consumer engagement length 222 and a long consumer engagement length 224. The report 302 can further include additional information, such as ratings or percentages of each of the stages identified above. For example, the box 306 can display 1,000 consumers for the awareness stage 206, box 308 can display 1,200 consumers for the familiarity/opinion stage 208, box 310 can display 800 consumers for the consideration stage 210, box 312 can display 750 consumers for the preference stage 212, box 314 can display 250 consumers for the shopping stage 214, box 316 can display 400 stage for the ownership experience/loyalty stage 218, box 318 can display 60% of consumers based on the short consumer engagement length 222, and box 320 display 40% of consumers based on the long consumer engagement length 224. A box 322 can display the header “Total Engagements” and another box 324 can display the number of total consumer engagements at the event (e.g., 4,400 consumer engagements).

In other words, during a conversation with a consumer at an event, a trained talent can identify where a guest or consumer fits in the consumer purchase funnel 304. The trained talent can make this determination in the early stages of the conversation, or engagement, with the consumer. The trained talent then can tailor the conversation with the consumer to help fulfill the consumer's needs for brand/product information, in an effort to help move the consumer further down the purchase funnel 304 toward a purchase decision. After each consumer engagement end the trained talent can utilize the system 100 to access the CET application on the device 112 and input information associated with various features into the CET application. For example, the trained talent may select a stage of the purchase funnel 304 that the consumer was in at the beginning of the conversation, the stage the consumer moved to during the course of the conversation. and the length of the conversation (e.g., short consumer engagement length 222 or long consumer engagement length 224). The trained talent may select the associated areas of the purchase funnel 304 on the device 112. This information can be logged by the CET application and available to review in real-time, for example, on the device 112 or the display 110.

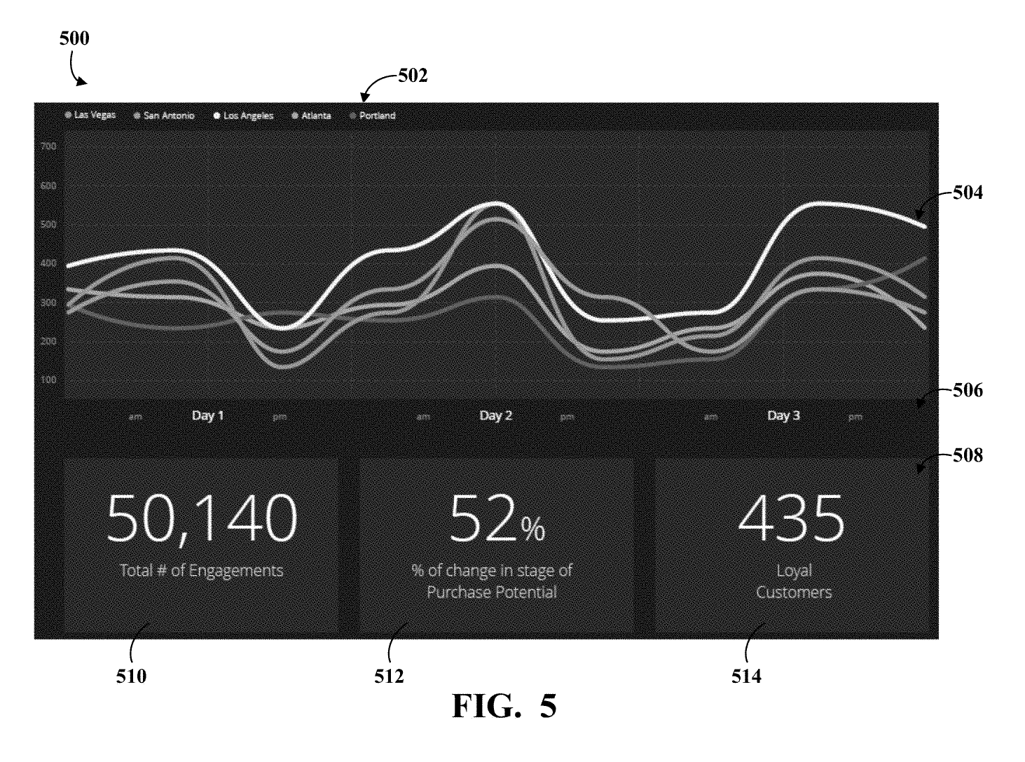

FIG. 4 illustrates an example process 400 of the system 100 in accordance with aspects of the present disclosure. At step 402, the system 100 can receive data, or input information, such as entrance data or arrived at input information. Entrance data may include where the consumer fits in the consumer purchase funnel 304 in the early stages of a conversation with the consumer. At step 404, the system 100 can receive data or input information, such as exit data or left at input information. Exit data may include where the consumer fits in the consumer purchase funnel 304 at the end of a conversation with the consumer. At step 406, the system 100 can receive time data or input information. The system 100 may also automatically determine the length of the interaction or consumer engagement. The interaction may be between the trained talent and the consumer, or any other desired person. The system 100 may obtain the information in steps 402-406 from a user, such as the trained talent, the consumer, or from another source, such as a sensor or directly from the device 112. At step 408, the system 100 can analyze the data or input information. The data may include the data obtained in steps 402-406. At step 410, the system 100 can output results, such as an analysis. The analysis may be based on the analyzed data or input information. The results may be output to the device 112, the display 110, or another desired device. The process 400 may include additional and/or fewer steps or data and is not limited to those illustrated in FIG. 4.

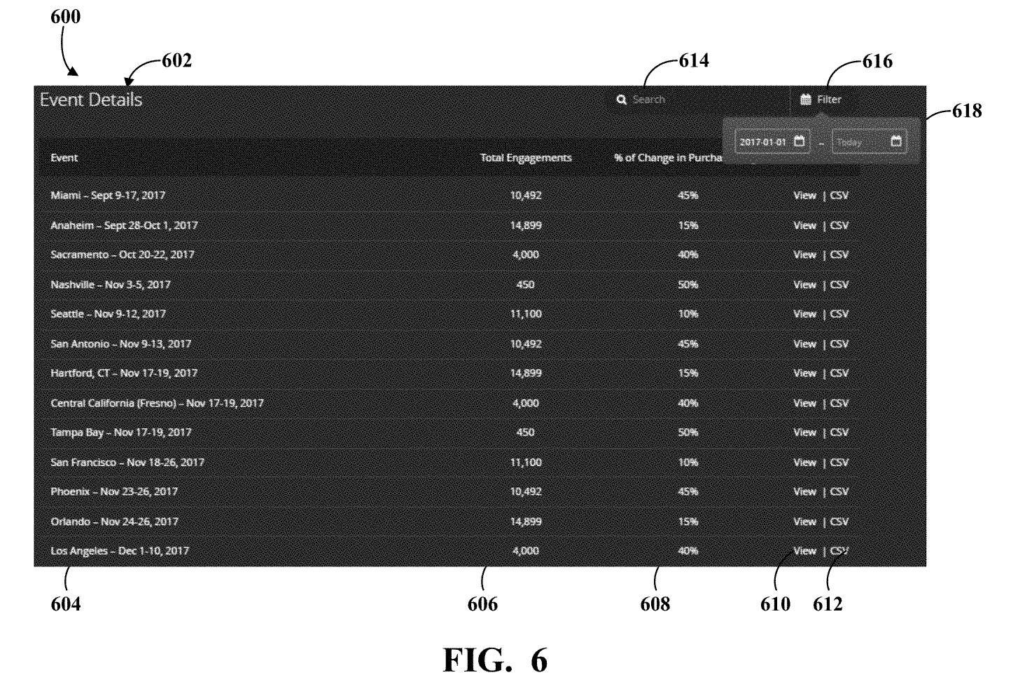

As shown in FIGS. 5-10, all of the aggregate input information collected by system 100 may be output as graphic displays or visual reports, or any other desired report. The data, or input information, for each individual event or all events in a specific timeframe may be analyzed and displayed, in various ways. For example, the report can include at least one of the total number of consumer engagements/interactions, consumer traffic flow over time/dates, the number of current owners/brand customers who interacted with the trained talent, the length of conversations during consumer engagements, and/or the associated impact on the change in the stages of consumers within the purchase funnel 304. Changes in the purchase funnel stage 304 may include the number of consumers who started a conversation in a specific stage, the number of consumers who ended a conversation in the specific stage, the number of consumers who changed stages, the percentage of change in each stage, and the overall percentage of consumers who changed stages in the purchase funnel 304. The information and reports may be output and viewable via an application or an administrator portal. The administrator portal may be accessed by inputting login credentials, such as a user name and password. The CET application or portal may include additional features, such as training and/or a help/FAQ section that provide guidance in determining a consumer's position in the purchase funnel 304. Additionally, the user may select graphics or reports that include final reports or purchasing potential. When the user is finished with the CET application, the user may sign out or otherwise exit the CET application or portal. The system 100 may be accessed through various applications, such as a webpage or an application for a mobile device or computer. The graphics or reports may include additional and/or fewer components and are not limited to those illustrated in FIGS. 5-10.

FIG. 5 illustrates an example report 500 displaying a comparison of the previous five events in accordance with aspects of the present disclosure. The report 500 can include a header 502, lines 504, a timeline 506, and a summary section 508. The header 502 can include identifiers of each of the previous five events. The identifiers in the report 500 can include the names of the cities where the events took place. Each of the indicators can correspond to one of the lines 504. For example, each indicator may be a different color or shape and corresponds to a line 504 with the same feature. The lines 504 can represent the number of consumer engagements at each event, throughout the event, and at any point along the timeline 506. The timeline 506 may include a day of an event, a time period during an event (e.g., am or pin), or another time period, such as dates of the events. In the report 500, the lines 504 can illustrate various peaks and valleys over the course of the three-day period, with the number of consumer engagements highest overall during the example Los Angeles Auto Show event. The summary section 508 can include summaries 510, 512, and 514. Summary 510 can include a combined total number of consumer engagements for all five events. Summary 512 can include a combined percentage of change in the stage of purchase potential of the consumers engaged with at all the events. Summary 514 can include a combined number of loyal customers engaged with at all the events.

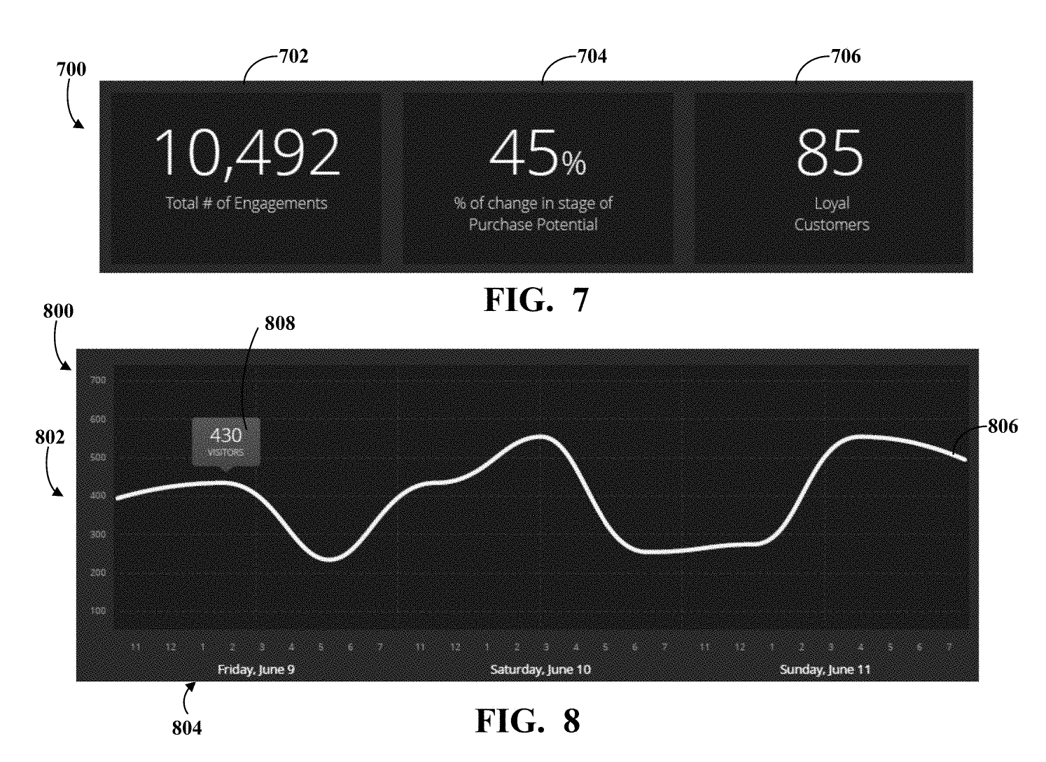

FIG. 6 illustrates an example list 600 of event details in accordance with aspects of the present disclosure. The list 600 can include a header 602, lists 604, 606, and 608, links 610 and 612, a search box 614, and a filter 616. The header 602 can include the type of page or screen displayed, such as “Event details.” The list 604 can include a list of the events, including, for example, the names of the cities and dates of the events. The list 606 can include the number of total engagements for each of the events listed in the list 604. Similarly, the list 608 can include the percentage of change in the category or stages of purchase potential of the consumers engaged with at each of the events in the list 604. The link 610 may be a link to view a page, screen, or document containing information about the corresponding event. The link 612 may be a link to a document, such as a spreadsheet in a .csv, .xml, .xls, .xlt, .xlsx, .xlsm, or any other desired format. When selected, the links 610 and 612 may allow a user to view, download, save, or perform any other desired operation to the corresponding document. The search box 614 may allow a user to search for events or other information. The filter 616 may allow a user to filter the search results. For example, the user may filter the results to a specific date range using a filter range 618. If more results are listed than displayed in the list 600, the user may navigate to another page to view the additional results.

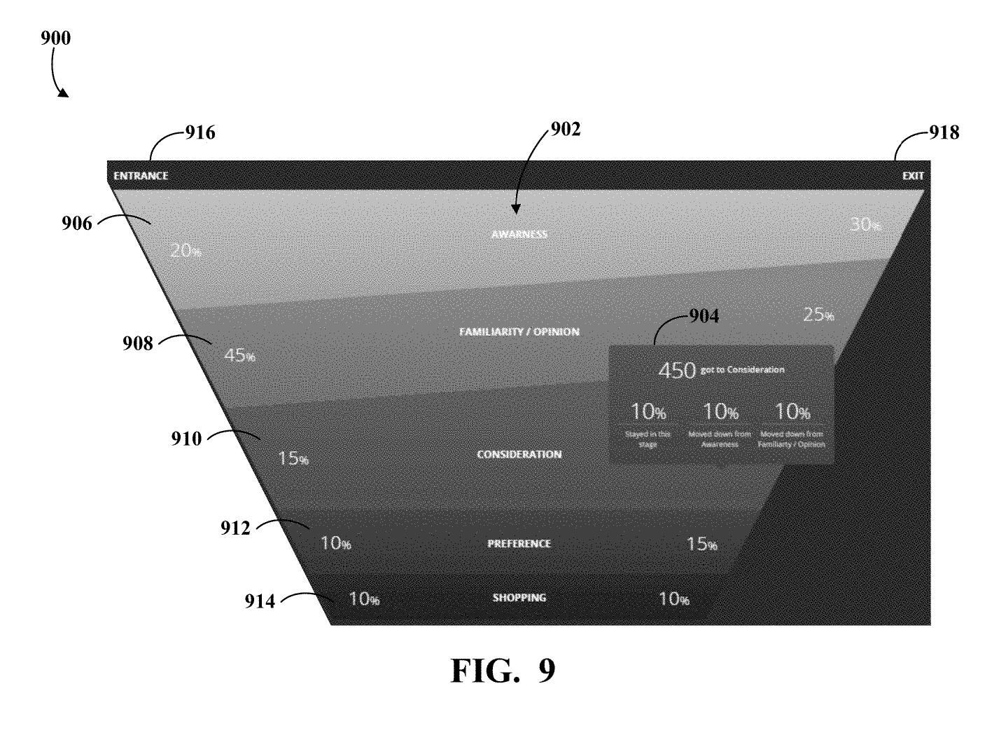

FIGS. 7-10 illustrate an example report including purchase funnel analytics of a single event. The example event is a Los Angeles Auto Show (e.g., Auto Show from Dec. 1-10, 2017. FIG. 7 illustrates an example summary section 700, summarizing the data collected and analyzed from the Auto Show. The summary section 700 can include summaries 702, 704, and 706. The summary 702 can include a total number of consumer engagements for the Auto Show (e.g., 10,492 engagements). The summary 704 can include a percentage of change in the categories or stages of purchase potential of the consumers engaged with at the Auto Show (e.g., 45% changed stages). The summary 706 can include the number of loyal customers the trained talent engaged with at the Auto Show (e.g., 85 loyal customers).

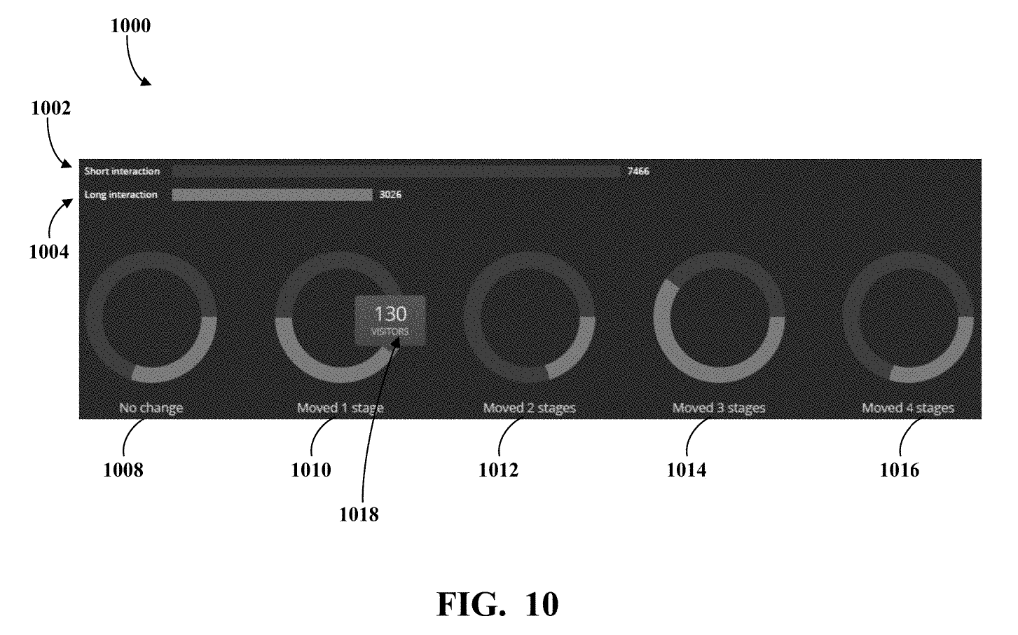

FIG. 8 illustrates an example graph 800 of the total number of consumer engagements over time at the Auto Show. The graph can include a y-axis 802 and an x-axis 804. The y-axis 802 can include the number of consumer engagements at the Auto Show (e.g., 100, 200 . . . 700). The x-axis 804 can include a timeline of the Auto Show (e.g., Friday, Saturday, and Sunday, including the hours of operation each day). The line 806 may indicate the number of consumer engagements at the Auto Show throughout the event. The x-axis 804 (e.g., the timeline) may include the day of an event, the time period during an event (e.g., am or pm), or another time period, such as dates of the events. In graph 800, the line 806 can illustrate various peaks and valleys over the course of a three-day period, with the highest number of consumer engagements each day occurring in the early afternoon and the lowest number occurring close to opening and closing times. A user may select different points along the line 806. At each selected point, a box 808 can be displayed with specific information of that point. For example, the information displayed in the box 808 can be “430 visitors,” which may indicate that the trained talent engaged with 430 consumers at approximately 2 pm on Friday, Jun. 9.

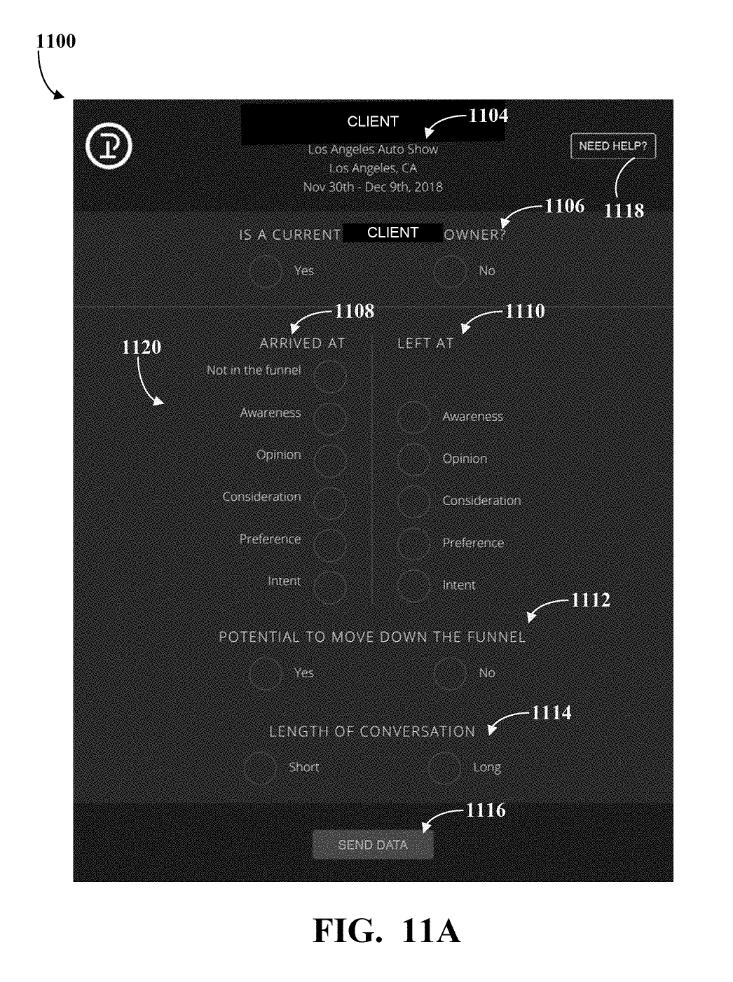

FIG. 9 illustrates an example purchase path analysis 900 of the event in accordance with aspects of the present disclosure. Similar to the consumer purchase funnel 304 in FIGS. 2-3, the purchase path analysis 900 can include a purchase funnel 902, such as an upside down triangle, trapezoid, funnel, or any other desired shape, broken up into multiple stages. The stages can include an awareness stage 906, a familiarity/opinion stage 908, a consideration stage 910, a preference stage 912, and a shopping stage 914. The purchase path analysis 900 may further indicate an entrance 916 and an exit 918. The entrance 916 can be located on the left side of the purchase path analysis 900. The entrance 916 may indicate the stage of consumers when the engagement begins. The exit 918 can be located on the opposed right side of the purchase path analysis 900. The exit 918 may indicate the stage of consumers when the engagement ends. The entrance 916 and exit 918 may be located on the alternative sides of the purchase path analysis 900. At the Auto Show, the trained talent identified 20% of consumers as being in the stage for the awareness stage 906 at the entrance 916 and 30% at the exit 918. The 10% difference in percentage may indicate that 10% of consumers changed stages, such that 10% more consumers were identified as being in the awareness stage 906 at the exit 918 than at the entrance 916. Some of the consumers may have remained in the awareness stage 906 while others have left and/or entered this stage. Likewise, 15% of consumers were identified as being in the consideration stage 910 at the entrance 916, and 20% at the exit 918, indicating a 5% increase of consumers in this stage upon the exit 918. Similarly, 10% of consumers were identified as being in the preference stage 912 at the entrance 916 and 15% at the exit 918, indicating a 5% increase of consumers in this stage upon the exit 918. Alternatively, 45% of consumers were identified as being in the familiarity/opinion stage 908 at the entrance 916, but only 25% were in this stage at the exit 918. This change in percentage may indicate that there was a 20% decrease of consumers in this stage upon the exit 918.

The percentage of the consumers at the entrance 916 and the exit 918 remained constant at 10% for consumers identified as being in the stage for the shopping stage 914. The percentages of consumers identified at the entrance 916 and the exit 918 can be displayed in the respective stages under the entrance 916 and the exit 918 headings, respectively. Positioned within the purchase funnel 902 can be a box 904 that can display additional information when a user selects (or hovers over) a specific stage. For example, if the user selects the consideration stage 910, the box 904 displays that 450 of the consumers were identified as being in the stage for the consideration stage 910, and of those, 10% remained in this stage, 10% moved to this stage from the awareness stage 906, and 10% moved to this stage from the familiarity/opinion stage 908.

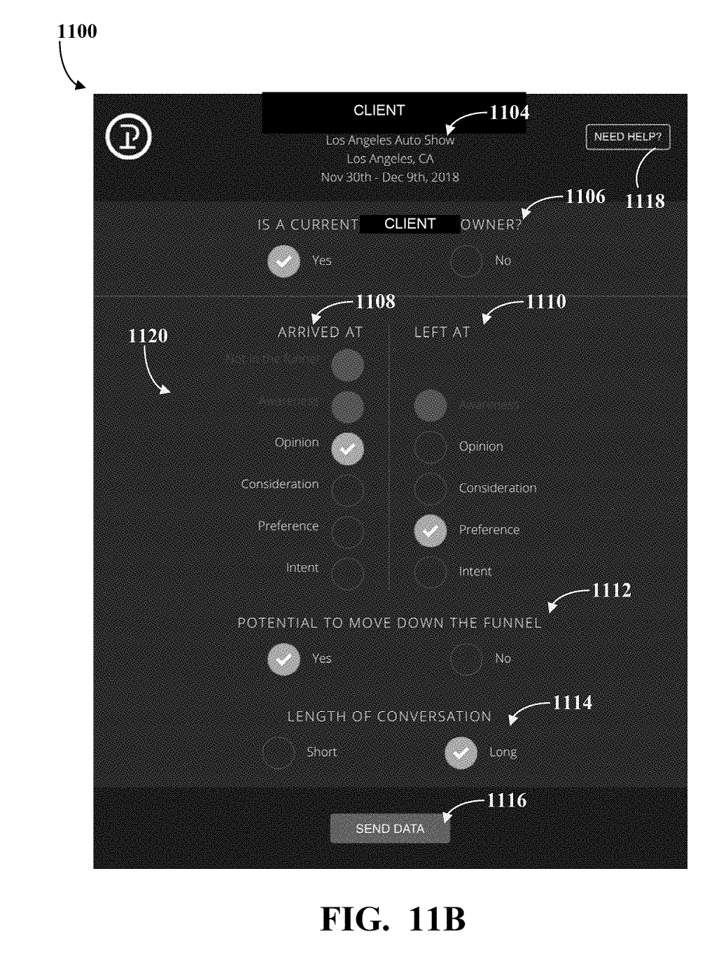

FIG. 10 illustrates an example report 1000 of an impact of engagement length and purchase funnel stage of an event in accordance with aspects of the present disclosure. The report 1000 can include bars 1002 and 1004 and rings 1008, 1010, 1012, 1014, and 1016. The bar 1002 can illustrate the number of short interactions (e.g., short consumer engagements) with consumers, represented by both a bar and a number (e.g., 7466 short consumer engagements). The bar 1004 can illustrate the number of long interactions (e.g., long consumer engagements) with consumers, represented by both a bar and a number (e.g., 3026 long consumer engagements). The amount of time allotted for the short or long consumer engagements may be predetermined or variable amounts of time. The lengths of the interactions may be input by the user, or a user may simply select the desired length (e.g., short or long consumer engagements). For example, the short consumer engagements may be for consumer engagements lasting less than or equal to three minutes, or any other desired amount of time. The long consumer engagements may be for consumer engagements lasting more than three minutes, or any other desired amount of time.

The rings 1008-1016 can illustrate the percentages of the lengths of interactions for consumers identified as remaining constant or changing stages. For example, the ring 1008 shows the lengths of consumer engagements for consumers who did not change categories (e.g., stages) and the rings 1010-1016 show the lengths of interactions for consumers who changed 1, 2, 3, or 4 stages, respectively. The bars 1002 and 1004 and the rings 1010-1016 may be color-coded or have another identifier to distinguish the two lengths of time. If a user selects or hovers over a ring, a box 1018 may display. The box 1018 can provide additional information, such as the number of consumer engagements for a certain length of time. In this example, the box 1018 displays “130 visitors,” which may indicate that the trained talent had 130 long interactions with consumers who moved one stage between the entrance 916 to the exit 918.

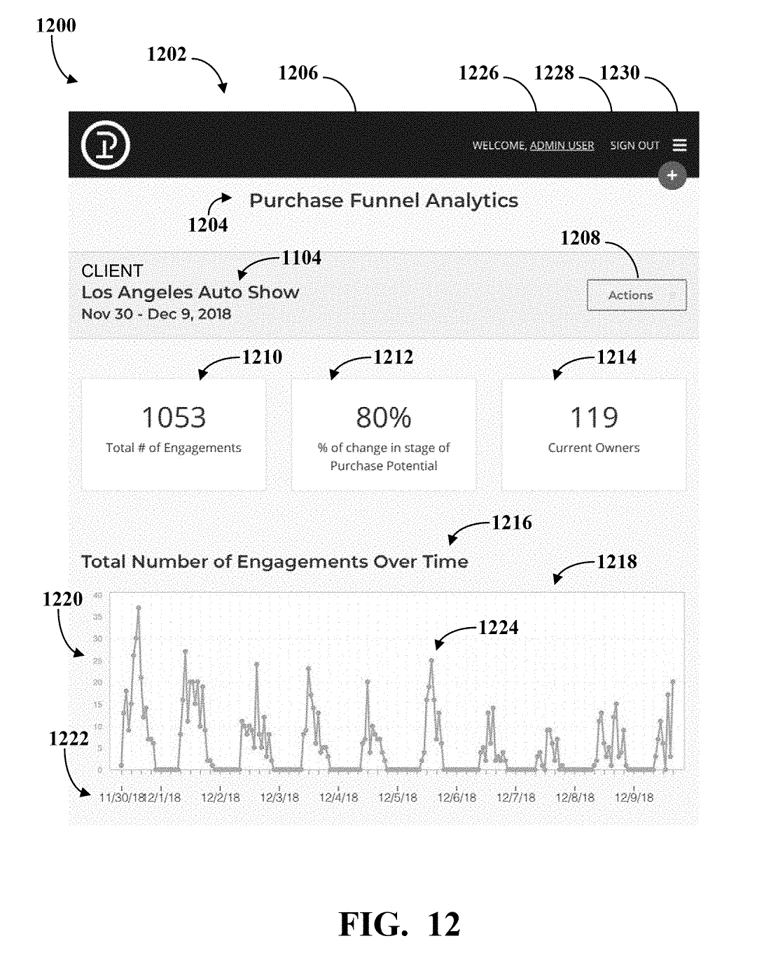

FIGS. 11A and 11B illustrate an example input interface 1100 for a user to input data or input information. The input interface 1100 can be accessed by a user using the system 100. As previously described, the system 100 can include multiple computing devices or a single computing device, such as a mobile phone, a tablet computer, a laptop computer, a desktop computer, a notebook computer, a server computer, or any other desired computing device.

The input interface 1100 can include a caption 1104. The caption 1104 can include client information, event information, dates, or any other desired information.

The input interface 1100 can include a data capture screen that may allow a user to log data obtained in a conversation during a consumer engagement as it relates to a potential buyer's affinity for a brand or product and the buyer's position in the purchase funnel. The input interface 1100 can be programmed to assist users with inputting information and reduce user errors with inputting correct information. For example, the input interface 1100 can include predetermined sections for a user to input information. The input interface 1100 can include radio buttons, check boxes, or any other desired selection or input feature for a user to input information.

The input information may be associated with a feature of a consumer engagement. For example, the input information may represent real-world characteristic of the feature of the consumer engagement.

The input interface 1100 can include an owner section 1106. The owner section 1106 can include an option for a user to input information associated with the consumer as a current owner of a client's product. For example, the user can input “YES” or “NO” in the owner section 1106.

The input interface 1100 can include a purchase funnel stage section 1120. The purchase funnel stage section 1120 can include one or more purchase funnel stages for a user to input information. The purchase funnel stage section 1120 can include an arrived at section 1108 and a left at section 1110. The arrived at section 1108 can include one or more purchase funnel stages for the user to input information associated with a consumer's purchase funnel stage at a beginning of the consumer engagement. For example, the purchase funnel stages in the arrive at section 1108 can include a not in the funnel stage, an awareness stage, an opinion stage, a consideration stage, a preference stage, and an intent stage. The left at section 1110 can include one or more purchase funnel stages for the user to input information associated with a consumer's purchase funnel stage at an end of the consumer engagement. For example, the purchase funnel stages in the left at section 1110 can include the awareness stage, the opinion stage, the consideration stage, the preference stage, and the intent stage.

The input interface 1100 can include a potential to move down the funnel section 1112. The potential to move down the funnel section 1112 can include the option for a user to input information associated with the consumer's potential to move down the purchase funnel. For example, the user can input “YES” or “NO” in the potential to move down the funnel section 1112.

The input interface 1100 can include a length of conversation section 1114. The length of conversation section 1114 can include the option for a user to input information associated with the length of the conversation during the consumer engagement. For example, the user can input “LONG” or “SHORT” in the length of conversation section 1114. The long length of conversation may be input if the conversation was greater than 3 minutes in length. The short length of conversation may be input if the conversation was less than 3 minutes in length.

The input interface 1100 can include other sections, including but not limited to a product of interest section. The product of interest section can include selection options, such as radio buttons, associated with different products. For example, the input interface 1100 can be associated with Client A. The product of interest section can include Client A's products, such as various Client A vehicles, together with selection options for a user to input information based on the product of interest identified during a consumer engagement.

The input interface 1100 can include a send data button 1116. When the user has finished inputting information associated with the consumer engagement, the user may select the send data button 1116 to send the input information. For example the input information can be stored in the memory 106 and the processor 104 can access the input information to generate a report associated with the input information in accordance with aspects of this disclosure.

The input interface 1100 can include a help button 1118. The help button 1118 can provide additional information for using the input interface 1100 or provide any other desired information. For example, a user can select the help button 1118, the input interface 1100 can display purchase funnel help information. The purchase funnel help information can include types of questions or comments that can help a user indicate at which level a consumer arrives at or leaves at within the purchase funnel. The not in the funnel stage can include questions or comments associated with the consumer not interested in the brand. The awareness stage can include questions or comments associated with the consumer not knowing anything about the brand, merely hearing about a brand, and used to knowing about the brand but does not have current information. The opinion stage can include questions or comments associated with the consumer liking the brand and/or products, not liking the brand much but changing the consumer's mind, having a good or bad experience with the brand in the past, and liking the latest commercials or advertising campaign. The consideration stage can include questions or comments associated with a consumer looking for products that the brand makes, wanting to know more about the features and benefits, and going to try out the product when the consumer is ready to purchase it. The preference stage can include questions or comments associated with the consumer liking the brand or product more than the competitor's brand or product, telling people to buy products form this brand, purchasing type of product soon and may test products before making a final decision to purchase product. The intent stage can include questions or comments associated with the consumer going to test the product soon and will probably buy the product in the short term and being decided to by the product in the short term.

FIG. 11A illustrates an example blank example of the input interface 1100. FIG. 11B illustrates an example input interface 1100 after the user has input information. 1n this example, the user input information that the consumer was a current owner of the client's product by inputting “YES” in the current client owner section 1106. The user input information that the consumer arrived at the consumer engagement in the opinion stage and left at the preference stage by checking the associated radio buttons in the arrived at section 1108 and the left at section 1110, respectively. To reduce user input error, incorrect information may not be available for a user to input. For example, the left at section 1110 may not include the not in the funnel stage because after the consumer engagement, the consumer would likely have gained enough information to be in at least an awareness stage at the end of the consumer engagement. If the user inputs information at a stage, the available information at higher stages may be unavailable for inputting information. In this example, the user input the opinion stage in the arrived at section 1108, so the higher section of the awareness stage may not be available to input information in the left at section 1110. The user input information that the consumer has potential to move down the funnel by inputting “YES” in the potential to move down the funnel section 1112. The user input information that the consumer engagement was long by inputting “LONGS” in the length of conversation section 1114. After the send data button 1116 is selected, the information can be submitted and the input interface 1100 can return to the blank example illustrated in FIG. 11A.

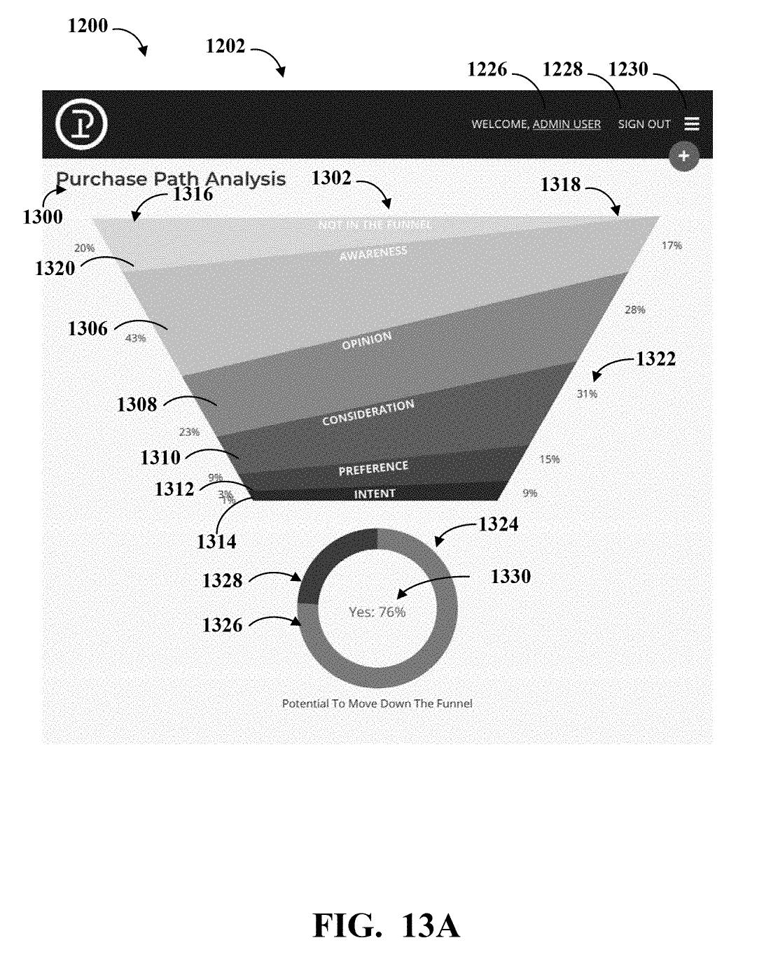

FIGS. 12-14 illustrate an example interface 1200. The interface 1200 can include an example report 1202. The interface 1200 can include a header 1206. The header 1206 can include options for a user to select, such as a user section 1226, a sign out section 1228, a more options selection 1230, and any other desired selection. The user selection 1226 can permit a user to change the user information for the report 1202. The sign out section 1228 can permit a user to sign out of the report 1202 or the interface 1200. The more options selection 1230 can include additional options for a user to select, such as a help menu or any other desired feature.

The report 1202 can include one or more key metrics. For example, the key metric may include a purchase funnel analytics 1204. The purchase funnel analytics 1204 can include a number of total engagements in a section 1210. The purchase funnel analytics 1204 can include a percent of consumers who changed a stage in the purchase funnel in section 1212. The purchase funnel analytics 1204 can include a number of current owners who participated in conversations in section 1214.

The purchase funnel analytics 1204 can display the percentage and number of consumer engagements as they relate to the levels of the purchase funnel and impact of consumer engagement on the change in purchase funnel position or stages, such as the not in the funnel stage, the awareness stage, the opinion stage, the consideration stage, the preference stage, the intent stage, and if the consumer is likely to still move down in the purchase funnel.

The report 1202 can include a tracking of the number of consumer engagements over time s in section 1216. Section 1216 can include a graph 1218 with a y-axis 1220 for the number of consumer engagements and an x-axis 1222 for the dates and/or times of the consumer engagements. A line 1224 can indicate the number of consumer engagements over time.

The interface 1200 can include an actions section 1208. The actions section 1208 can include options for a user to select. For example, the user can select the actions section 1208 and a list of options can pop up. The options for the user to select can include to view all reports, print final report, download data, invite product specialist, or any other desired selection.

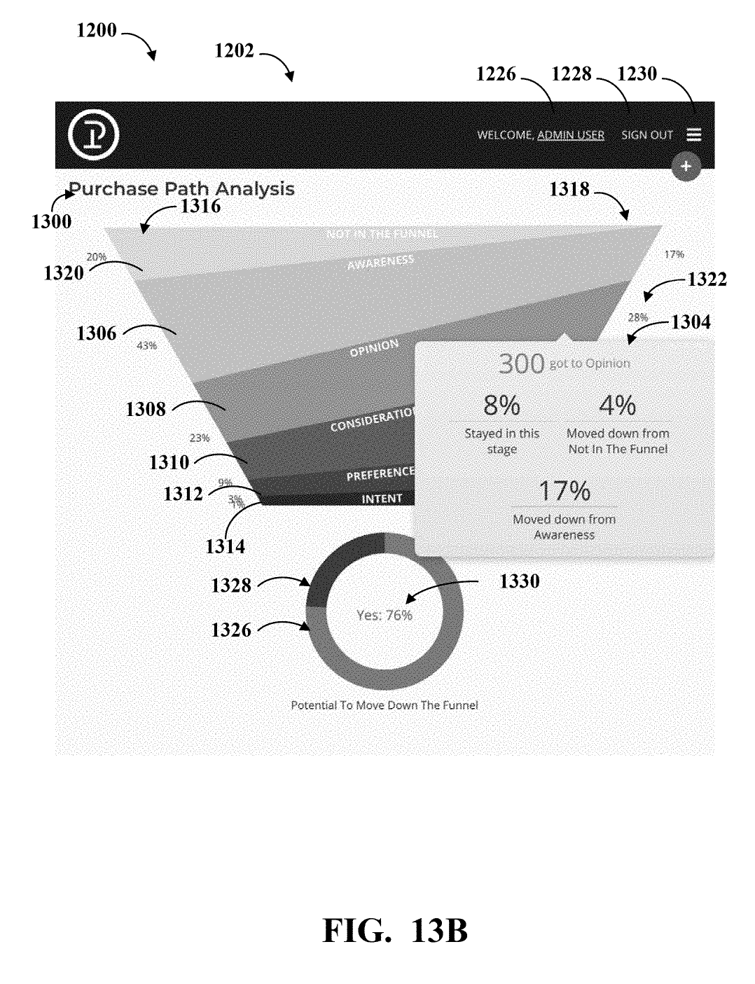

The report 1202 can also include key metric that can include a purchase path analysis 1300 as illustrated in FIGS. 13A and B. Similar to the descriptions described above and in FIGS. 2, 3, and 9, the purchase path analysis 1300 can include a purchase funnel 1302, such as an upside down triangle, trapezoid, or funnel broken up into multiple stages, or any other desired shape or configuration. The categories or stages can include a not in the funnel stage 1320, an awareness stage 1306, an opinion stage 1308, a consideration stage 1310, a preference stage 1312, and an intent stage 1314. The purchase path analysis 1300 can further include an entrance 1316 and an exit 1318. The entrance 1316 can be located on the left side of the purchase path analysis 1300. The entrance 1316 can indicate the stage of consumers when the engagement begins. The exit 1318 can be located on the opposed right side of the purchase path analysis 1300. The exit 1318 can indicate the stage of consumers when the engagement ends. The entrance 1316 and exit 1318 may be located on the alternative sides of the purchase path analysis 1300 or any other desired location. The purchase path analysis 1300 can include percentages of consumers who started at or ended at a stage. For example, a percentage 1322 can indicate that 31% of consumers left the consumer engagement in the consideration stage 1310.

The purchase path analysis 1300 can also include a potential to move down the funnel 1324. The potential to move down the funnel 1324 can be displayed as a pie chart, a circular bar graph, or any other desired display. The potential to move down the funnel 1324 can include a first section 1326 to indicate the number or percentage of consumers who have potential to move down the purchase funnel. The potential to move down the funnel 1324 can include a second section 1328 to indicate the number or percentage of consumers who have potential to move down the purchase funnel. The first and second sections 1326, 1328 can be different colors, designs, or include other features to differentiate between the two sections. In this example, the first section 1326 may be associated with the consumers identified as having potential to move down the purchase funnel. The second section 1328 may be associated with consumers identified as not having potential to move down the purchase funnel. The potential to move down the funnel 1324 can include a section 1330 to indicate the number or percentage of consumers who have potential to move down the purchase funnel. The section 1330 may display that 76% of consumers have a potential to move down the purchase funnel.

FIG. 13B illustrates an example pop-up 1304. If a user selects or hovers over the purchase funnel, the pop-up box 1304 may display. The pop-up 1304 can display the number of consumers identified at a stage at the end of the consumer engagement. The pop-up 1304 can display the percentage of consumers who stayed in a stage, moved down from a stage, moved down form a higher stage, or any other desired information. In this example, 300 consumers were identified as having left the consumer engagement at the opinion stage 1308, 8% of these consumers stayed in the opinion stage 1308, 4% of the consumers moved down from the not in funnel stage 1320, and 17% moved down from the awareness stage 1306.

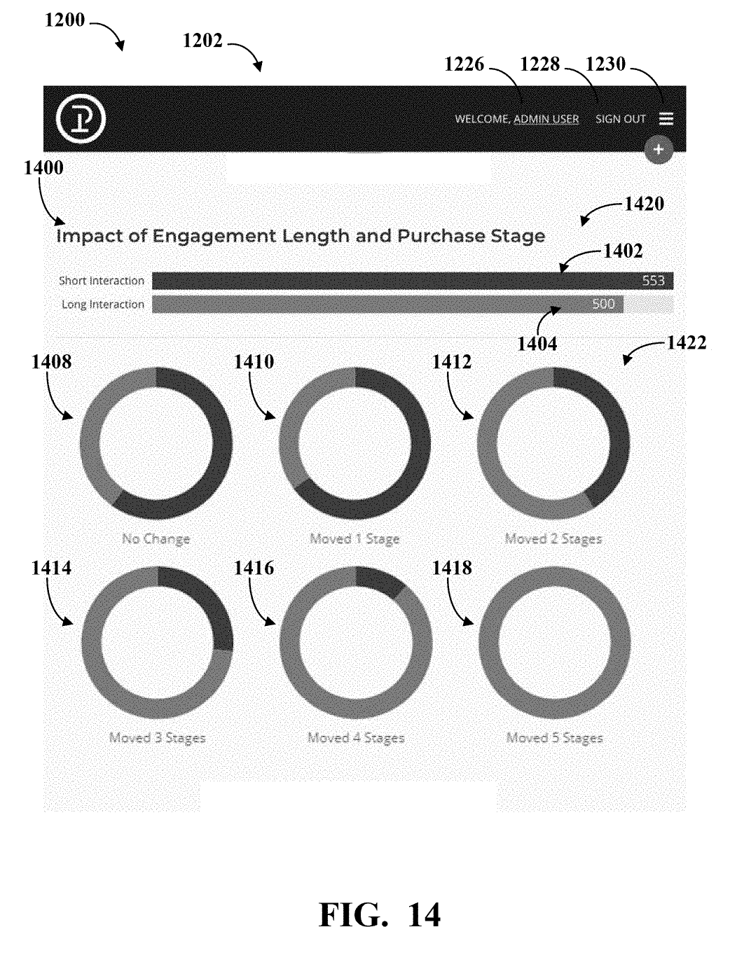

As illustrated in FIG. 14, the report 122 can include key metrics for an impact of engagement length and purchase funnel stage 1400. Similar to the descriptions in FIG. 10, the impact of engagement length and purchase funnel stage 1400 can include an engagement length impact section 1420 and a purchase funnel stage impact section 1422. The engagement length impact section 1420 can include a short interaction section 1402 and a long interaction section 1404. The short and long interaction sections 1402, 1404 can be displayed as a bar graph or any other desired graphic. The short and long interaction sections 1402, 1404 can include numbers of the consumers having short or long interactions during the respective consumer engagements. The short and long interaction sections 1402, 1404 can include different colors or graphics for a user to easily distinguish between the two lengths of time.

Similarly, the lengths of time can be displayed in the purchase funnel stage impact section 1422 that include different colors or graphics for a user to easily distinguish between the two lengths of time. Rings 1408, 1410, 1412, 1414, 1416, and 1418 each can include the lengths of the consumer engagements during different levels of impact on the purchase funnel stage. For example, ring 1408 can display the lengths of the consumer engagements with no change in purchase funnel stage. Similarly, ring 1410 can display the impact when consumers moved one stage, ring 1410 for moving two stages, ring 1412 for moving three stages, ring 1414 for moving three stages, ring 1416 for moving four stages, and ring 1418 for moving five stages.

One example embodiment according to principles of the present disclosure can include a system for tracking consumer engagements. The system can include a non-transitory computer-readable storage medium and a processor. The non-transitory computer-readable storage medium can include instructions executable by the processor to perform operations. The processor can receive, from a first computing device, a first user input information corresponding to a first feature. The processor can store the first user input information corresponding to the first feature in a memory associated with the processor. The processor can receive from a second computing device, a second user input information corresponding to the first feature. The processor can store the second user input information corresponding to the first feature in the memory. The processor can generate a first key metric using at least the first user input information and the second user input information corresponding to the first feature. The processor can store the first key metric in the memory. The processor can receive a first report request from a third computing device. In response to the first report request, the processor can retrieve, from the memory, a plurality of key metrics, including at least the first key metric; generate a first report using the plurality of key metrics; and communicate, for display, the first report to the third computing device.

In this example, the first key metric can be associated with at least one of an ownership status, a purchase funnel stage, a purchase funnel stage change potential, a length of the consumer engagement, and a product of interest. The purchase funnel stage can be at least one of a not in the funnel stage, an awareness stage, an opinion stage, a consideration stage, a preference stage, and an intent stage.

The first report can include at least one of a total number of consumer engagements, a percentage of consumers engagement, a number of current owners, a purchase path analysis, an impact of consumer engagement length and purchase funnel stage, and a product of interest. The purchase path analysis can include at least one of the total number of consumer engagements associated with the purchase funnel stage, the percentage of consumer engagements associated with the purchase funnel stage, and an impact of the consumer engagement associated with on a change in the purchase funnel stage. The purchase path analysis can also include a purchase funnel having a plurality of purchase funnel stages positioned sequentially from a large portion of the purchase funnel to a small portion of the purchase funnel. The impact of consumer engagement length and purchase funnel stage can be associated with an analysis of lengths of the consumer engagements and changes in the purchase funnel stages.

The non-transitory computer-readable storage medium can include further instructions executable by the processor to receive, from the first computing device, the first user input information corresponding to a second feature. The processor can store the first user input information corresponding to the second feature in the memory associated with the processor. The processor can receive from the second computing device, a second user input information corresponding to the second feature. The processor can store the second user input information corresponding to the second feature in the memory. The processor can generate a second key metric using at least the first user input information and the second user input information corresponding to the second feature. The processor can store the second key metric in the memory. The processor can receive a second report request from a third computing device. In response to the second report request, the processor can retrieve, from the memory, the plurality of key metrics, including at least the first key metric and the second key metric; generate a second report using the plurality of key metrics; and communicate, for display, the second report to the third computing device.

In this example, the first key metric can be associated with a purchase funnel stage at a beginning of the consumer engagement and the second key metric may be associated with the purchase funnel stage at an end of the consumer engagement. The second report can include a purchase funnel including the first key metric and the second key metric, or any other desired key metric.

Another example embodiment according to principles of the present disclosure can include a non-transitory computer-readable storage medium, comprising executable instructions that, when executed by a processor of a computing device, facilitate a performance of operations for tracking consumer engagements. The processor can perform operations of receiving, from a plurality of user computing devices, a plurality of first input information corresponding to a first feature and storing the plurality of first input information in a memory associated with the processor. The processor can perform operations of generating a first key metric using the plurality of first input information and storing the first key metric in the memory. The processor can perform operations of receiving a report request from a client computing device. For example, the client computing device can be a mobile phone, a tablet computer, a laptop computer, a desktop computer, a notebook computer, a server computer, or any other desired computing device. In response to the report request, the processor can perform operations of retrieving, from the memory, a plurality of key metrics, including at least the first key metric; generating a report using the plurality of key metrics; and communicating, for display, the report to the client computing device.

In this example, the first key metric can be associated with at least one of a total number of consumer engagements, lengths of the consumer engagements, an ownership status, a purchase funnel stage, a purchase funnel stage change potential, a length of the consumer engagement, and a product of interest.

The first report can include at least one of a total number of consumer engagements, a percentage of consumers engagement, a number of current owners, a purchase path analysis, an impact of consumer engagement length and purchase funnel stage, and a product of interest. For example, the product of interest can include information associated with the ability to track products of interest, such as if a consumer is interested in a specific product.

The purchase path analysis can include at least one of the total number of consumer engagements associated with the purchase funnel stage, the percentage of consumer engagements associated with the purchase funnel stage, and an impact of the consumer engagement associated with on a change in the purchase funnel stage.

The first key metric can be stored in the memory in real-time and included in the first report in real-time. For example, after a user selects the send data button 1116, the processor can automatically generate and store the first key metric in the memory in real-time. The processor can automatically include the first key metric in the first report in real-time. Thus, when a user, such as a client, requests a report, information provided in the report may be current. The report can be automatically refreshed to include real-time information. The report can be manually refreshed by a user to include real-time information.

The non-transitory computer-readable storage medium can comprise further executable instructions that, when executed by a processor of a computing device, facilitate a performance of operations for tracking consumer engagements, including receiving, from the plurality of user computing devices, a plurality of second input information corresponding to a second feature and storing the plurality of second input information in the memory associated with the processor. The processor can perform operations of generating a second key metric using the plurality of second input information and storing the second key metric in the memory. The processor can perform operations of receiving a second report request from the client computing device. In response to the second report request, the processor can perform operations of retrieving, from the memory, a plurality of key metrics, including at least the first key metric and the second key metric; generating a second report using the plurality of key metrics; and communicating, for display, the second report to the client computing device.

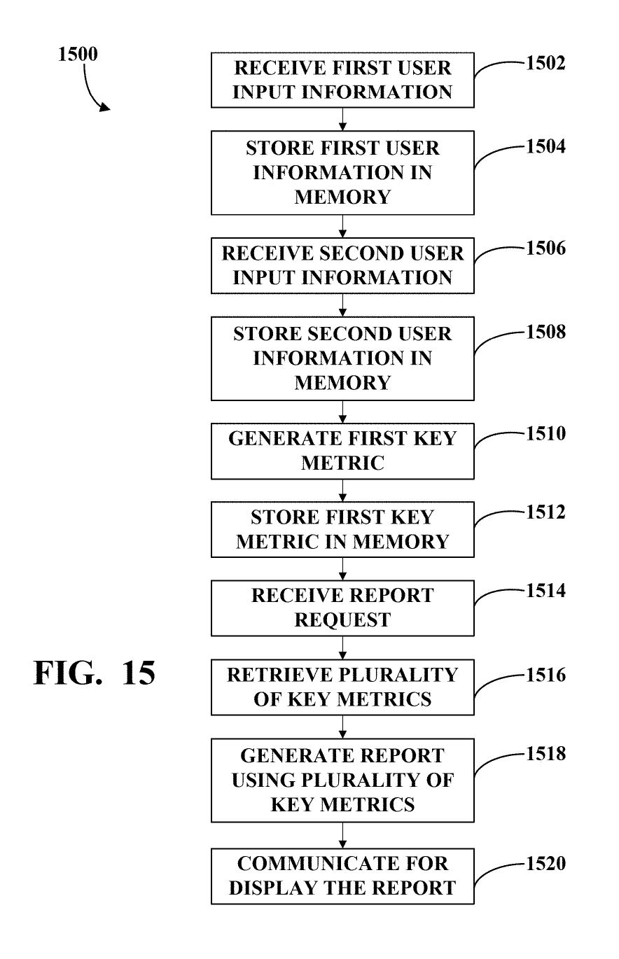

FIG. 15 is a flow diagram of an example process 1500 for tracking consumer engagement according to principles of the present disclosure. At step 1502, the process can receive, from a first computing device, a first user input information corresponding to a first feature. For example, a consumer engagement system can receive, as described, input information from a user using an input interface, such as input interface 1100. The input interface 1100 may be a data capture screen or any other desired input interface. In some embodiments, the input interface 1100 may be accessed by the user using a computing device, such as device 112. At step 1504, the process can store the first user input information corresponding to the first feature in a memory associated with the processor. At step 1506, the process can receive from a second computing device, a second user input information corresponding to the first feature. At step 1508, the process can store the second user input information corresponding to a first feature in the memory. At step 1510, the process can generate a first key metric using at least the first user input information and the second user input information corresponding to the first feature. For example, the first key metric can be associated with at least one of an ownership status, a purchase funnel stage, a purchase funnel stage change potential, a length of the consumer engagement, and a product of interest. At step 1512, the process can store the first key metric in the memory. At step 1514, the process can receive a first report request from a third computing device.

In response to the first report request, the process can retrieve, from the memory, a plurality of key metrics, including at least the first key metric (step 1516); generate a first report using the plurality of key metrics (step 1518); and communicate, for display, the first report to the third computing device (step 1520). For example, the first report can include at least one of a total number of consumer engagements, a percentage of consumers engagement, a number of current owners, a purchase path analysis, an impact of consumer engagement length and purchase funnel stage, and a product of interest.

The process can further comprise receiving, from the first computing device, the first user input information corresponding to a second feature and storing the first user input information corresponding to the second feature in a memory associated with the processor. The process can further comprise receiving from the second computing device, the second user input information corresponding to the second feature and storing the second user input information corresponding to the second feature in the memory. The process can further comprise generating a second key metric using at least the first user input information and the second user input information corresponding to the second feature and storing the second key metric in the memory. The process can further comprise receiving a second report request from the third computing device. In response to the second report request, the process can further retrieve, from the memory, a plurality of key metrics, including at least the first key metric and the second key metric; generate a second report using the plurality of key metrics; and communicate, for display, the second report to the third computing device.

For example, the first key metric can be associated with a purchase funnel stage at a beginning of the consumer engagement and the second key metric may be associated with the purchase funnel stage at an end of the consumer engagement. The second report can include a purchase funnel including the first key metric and the second key metric and any other desired metric.

The process 1500 may include additional and/or fewer processes and is not limited to those illustrated in FIG. 15.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system for tracking consumer engagements, comprising:
a non-transitory computer-readable storage medium; and
a processor, wherein the non-transitory computer-readable storage medium can include instructions executable by the processor to:
receive, from a first computing device, a first user input information corresponding to a first feature;
store the first user input information corresponding to the first feature in a memory associated with the processor;
receive from a second computing device, a second user input information corresponding to the first feature;
store the second user input information corresponding to the first feature in the memory;
generate a first key metric using at least the first user input information and the second user input information corresponding to the first feature;
store the first key metric in the memory;
receive a first report request from a third computing device; and
in response to the first report request:
retrieve, from the memory, a plurality of key metrics, including at least the first key metric;
generate a first report using the plurality of key metrics; and
communicate, for display, the first report to the third computing device.

2. The system of claim 1, wherein the first key metric is associated with at least one of an ownership status, a purchase funnel stage, a purchase funnel stage change potential, a length of the consumer engagement, and a product of interest.

3. The system of claim 2, wherein the purchase funnel stage is at least one of a not in the funnel stage, an awareness stage, an opinion stage, a consideration stage, a preference stage, and an intent stage.

4. The system of claim 1, wherein the first report can include at least one of a total number of consumer engagements, a percentage of consumers engagement, a number of current owners, a purchase path analysis, an impact of consumer engagement length and purchase funnel stage, and a product of interest.

5. The system of claim 4, wherein the purchase path analysis can include at least one of the total number of consumer engagements associated with the purchase funnel stage, the percentage of consumer engagements associated with the purchase funnel stage, and an impact of the consumer engagement associated with on a change in the purchase funnel stage.

6. The system of claim 4, wherein the purchase path analysis can include a purchase funnel having a plurality of purchase funnel stages positioned sequentially from a large portion of the purchase funnel to a small portion of the purchase funnel.

7. The system of claim 4, wherein the impact of consumer engagement length and purchase funnel stage is associated with an analysis of lengths of the consumer engagements and changes in the purchase funnel stages.

8. The system of claim 1, wherein the non-transitory computer-readable storage medium can include further instructions executable by the processor to:
receive, from the first computing device, the first user input information corresponding to a second feature;
store the first user input information corresponding to the second feature in the memory associated with the processor;
receive from the second computing device, a second user input information corresponding to the second feature;
store the second user input information corresponding to the second feature in the memory;
generate a second key metric using at least the first user input information and the second user input information corresponding to the second feature;
store the second key metric in the memory;
receive a second report request from a third computing device; and
in response to the second report request:
retrieve, from the memory, the plurality of key metrics, including at least the first key metric and the second key metric;
generate a second report using the plurality of key metrics; and
communicate, for display, the second report to the third computing device.

9. The system of claim 8, wherein the first key metric is associated with a purchase funnel stage at a beginning of the consumer engagement and the second key metric is associated with the purchase funnel stage at an end of the consumer engagement; and
wherein the second report can include a purchase funnel including the first key metric and the second key metric.

10. A non-transitory computer-readable storage medium, comprising executable instructions that, when executed by a processor of a computing device, facilitate a performance of operations for tracking consumer engagements, comprising:
receiving, from a plurality of user computing devices, a plurality of first input information corresponding to a first feature;
storing the plurality of first input information in a memory associated with the processor;
generating a first key metric using the plurality of first input information;
storing the first key metric in the memory;
receiving a report request from a client computing device; and
in response to the report request:
retrieving, from the memory, a plurality of key metrics, including at least the first key metric;
generating a report using the plurality of key metrics; and
communicating, for display, the report to the client computing device.

11. The non-transitory computer-readable storage medium of claim 10, wherein the first key metric is associated with at least one of a total number of consumer engagements, lengths of the consumer engagements, an ownership status, a purchase funnel stage, a purchase funnel stage change potential, a length of the consumer engagement, and a product of interest.

12. The non-transitory computer-readable storage medium of claim 11, wherein the first report can include at least one of a total number of consumer engagements, a percentage of consumers engagement, a number of current owners, a purchase path analysis, an impact of consumer engagement length and purchase funnel stage, and a product of interest.

13. The non-transitory computer-readable storage medium of claim 12, wherein the purchase path analysis can include at least one of the total number of consumer engagements associated with the purchase funnel stage, the percentage of consumer engagements associated with the purchase funnel stage, and an impact of the consumer engagement associated with on a change in the purchase funnel stage.

14. The non-transitory computer-readable storage medium of claim 11, wherein the first key metric is stored in the memory in real-time and included in the first report in real-time.

15. The non-transitory computer-readable storage medium of claim 10, comprising further executable instructions that, when executed by a processor of a computing device, facilitate a performance of operations for tracking consumer engagements, comprising:
receiving, from the plurality of user computing devices, a plurality of second input information corresponding to a second feature;
storing the plurality of second input information in the memory associated with the processor;
generating a second key metric using the plurality of second input information;
storing the second key metric in the memory;
receiving a second report request from the client computing device; and
in response to the second report request:
retrieving, from the memory, a plurality of key metrics, including at least the first key metric and the second key metric;
generating a second report using the plurality of key metrics; and
communicating, for display, the second report to the client computing device.

16. A method for a consumer engagement system, comprising:
receiving, from a first computing device, a first user input information corresponding to a first feature;
storing the first user input information corresponding to the first feature in a memory associated with the processor;
receiving from a second computing device, a second user input information corresponding to the first feature;
storing the second user input information corresponding to a first feature in the memory;
generating a first key metric using at least the first user input information and the second user input information corresponding to the first feature;
storing the first key metric in the memory;
receiving a first report request from a third computing device; and
in response to the first report request:
retrieving, from the memory, a plurality of key metrics, including at least the first key metric;
generating a first report using the plurality of key metrics; and
communicating, for display, the first report to the third computing device.

17. The method of claim 16, wherein the first key metric is associated with at least one of an ownership status, a purchase funnel stage, a purchase funnel stage change potential, a length of the consumer engagement, and a product of interest.

18. The method of claim 16, wherein the first report can include at least one of a total number of consumer engagements, a percentage of consumers engagement, a number of current owners, a purchase path analysis, an impact of consumer engagement length and purchase funnel stage, and a product of interest.

19. The method of claim 16, further comprising:
receiving, from the first computing device, the first user input information corresponding to a second feature;
storing the first user input information corresponding to the second feature in a memory associated with the processor;
receiving from the second computing device, the second user input information corresponding to the second feature;
storing the second user input information corresponding to the second feature in the memory;
generating a second key metric using at least the first user input information and the second user input information corresponding to the second feature;
storing the second key metric in the memory;
receiving a second report request from the third computing device; and
in response to the second report request:
retrieving, from the memory, a plurality of key metrics, including at least the first key metric and the second key metric;
generating a second report using the plurality of key metrics; and
communicating, for display, the second report to the third computing device.

20. The method of claim 19, wherein the first key metric is associated with a purchase funnel stage at a beginning of the consumer engagement and the second key metric is associated with the purchase funnel stage at an end of the consumer engagement; and
wherein the second report can include a purchase funnel including the first key metric and the second key metric.
